(19) United States
(12) Patent Application Publication
(10) Pub. No.: US 2003/0143910 A1
(43) Pub. Date: Jul. 31, 2003

(54) Carpet backings prepared from vegetable oil-based polyurethanes

(76) Inventors: Larry E. Mashburn, Rocky Faith, GA (US); William H. Harrison, Dalton, GA (US); Thomas E. Patterson, Tunnel Hill, GA (US)

Correspondence Address: Dennis P. Clarke, Miles & Stockbridge, Suite 500, 1751 Pinnacle Drive, McLean, VA, 22102, US

(21) Appl. No.: 10/059,278

(22) Filed: Jan. 31, 2002

(51) Int. Cl. B32B 5/02; B32B 3/02; B32B 33/00; B32B 27/12; D04H 11/00

(52) U.S. Cl. 442/149; 428/96; 428/97; 428/95; 442/221; 442/223; 442/224; 442/226; 428/318.4

(57) ABSTRACT

A carpet backing prepared from a polyurethane forming composition which comprises:

(A) a polyisocyanate and

(B) a mixture of a vegetable oil, a cross-linking agent comprised of a multi-functional alcohol present in a ratio to said vegetable oil such that there are at least 0.7 moles of OH groups per mole of bulk vegetable oil, a catalyst, and a blowing agent.

### BACKGROUND OF THE INVENTION

1. Field of the Invention

This invention relates to plastic elastomers and their method of preparation. Specifically, the present invention relates to flexible urethane foams and elastomers, useful as environmentally friendly carpet backings, prepared by the reaction between isocyanates, cross-linking agents, and vegetable oils, particularly blown soy oil.

2. Description of the Prior Art

Because of their widely ranging mechanical properties and their ability to be relatively easily machined and formed, plastic foams and elastomers have found wide use in a multitude of industrial and consumer applications. In particular, urethane foams and elastomers have been found to be well suited for many applications. Automobiles, for instance, contain a number of components, such as cabin interior parts, that are comprised of urethane foams and elastomers. Such urethane foams are typically categorized as flexible (or semi-rigid) or rigid foams; with flexible foams generally being softer, less dense, more pliable and more subject to structural rebound subsequent loading than rigid foams.

Various methods for the production of polyurethane backing on textiles for floor coverings, including carpets are known and described in, for example, U.S. Pat. Nos. 3,849,156, 4,035,529, 4,657,790 and 4,853,280. The process of U.S. Pat. No. 3,849,156 comprises applying a froth directly to the back of carpeting, shaping the froth into the desired shape, and curing the shaped froth at a temperature of at least 70 degrees. C. to form a polyurethane foam backing on the carpeting material. This polyurethane comprises a substantially non-aqueous mixture of a polyisocyanate, an active hydrogen-containing material, an organosilicon surfactant, and a catalyst having substantial activity only at temperatures of at least 70 degrees. C. An inert gas is dispersed throughout the mixture by mechanical beating of the mixture to form a heat curable froth. Carpet fibers and textile filaments may not be firmly enough locked into the carpeting by these mechanically frothed foams, i.e., the “tuft lock” strength may be too low to maintain integrity of the carpet under heavy use conditions.

U.S. Pat. No. 4,035,529 describes a process using two coats of polyurethane backings for floor coverings having improved fixing of textile filaments, i.e., higher “tuft lock”, and increased stiffness of the carpet. This process comprises applying a first coat to a textile floor covering, a precoat, which consists essentially of a polyol and a large excess of an isocyanate. To assure good intercoat adhesion between coats, a foamable main coat of substantially equivalent amounts of a polyol and an isocyanate are then applied before the first coat is hardened, and both coats are subsequently hardened in a heating zone. The “open time”, that is, the time that elapses between application of the precoat and the foamable main coat is limited.

U.S. Pat. No. 4,657,790 relates to the use of general polyurethane formulation in a specific process. This process comprises forming a precoat layer of a reaction mixture comprising a curable polymer-forming composition, separately forming a capcoat layer of a mixture comprising a curable polymer forming composition, contacting the precoat layer with one surface of the substrate before the precoat layer is tack free, contacting the capcoat layer with one surface of the precoat layer before either the precoat layer or the capcoat layer is tack free, completing the curing of the capcoat and precoat layers, and cooling the polymer backed substrate to less than about 35 degrees. C. before mechanical distortion. This process is carried out under conditions such that mechanically induced stress is minimized. This process has the disadvantage that the capcoat is produced separately and then laminated to the precoat in an additional manufacturing step.

The multi-layered polymer backed floor covering of U.S. Pat. No. 4,853,280 is releasable. It allows the entire installed carpet or carpet padding to be easily removed from the floor surface without tearing so that portions of it do not remain on the floor surface. The backing comprises a facing layer and a bottommost release backing layer both comprising a non-woven fabric, and a polymer layer bonded to the release layer on one side and directly or indirectly to the facing layer on the other side. A precoat layer may be used between the facing layer and the polymer layer. This backing is produced by applying a layer of an uncured polymer-forming composition to the back side of a textile, applying a layer of a non-woven fabric to the polymer backing, and curing the polymer forming composition to a tack free state. In order for the carpet to be releasable when a precoat is used, the adhesion between the precoat and foamable layer has to be sufficient to avoid delamination at that interface. Most commonly, latex-based precoats are used to assure adequate interfacial adhesion; however, these latex materials may potentially contain volatile organic compounds.

Polyurethane unitary layers that may be used as precoats are described, for example, in U.S. Pat. Nos. 4,269,159 and 4,696,849. Polyurethane-backed carpeting is the subject of U.S. Pat. No. 4,296,159. These carpets comprise a primary backing, a yam tufted or woven through the primary backing to create a bundle on the underside of the tufted good, and a polyurethane composition is then applied to the underside to encapsulate the yam bundles to the primary backing providing high “tuft lock”. This polyurethane composition comprises a high molecular weight polyether polyol, a low molecular weight polyol, and organic polyisocyanate or polyisothiocyanate, and an inorganic filler. The isocyanate used in the examples are either isocyanate prepolymers based on toluene diisocyanate, or a modified diphenylmethane thioisocyanate

U.S. Pat. No. 4,696,849 discloses polyurethane compositions suitable for carpet backing comprising the reaction product of a polyurethane-forming composition which comprises at least one relatively high equivalent weight polyol containing an average of about 1.4-1.95 hydroxyl groups per molecule, of which hydroxyl groups at least 30% are primary hydroxyls; a relatively low equivalent weight compound having about 2 active hydrogen containing moieties per molecule; a polyisocyanate and a catalyst. Toluene diisocyanate 2,4- and 4,4-diphenyl methane diisocyanates and the isocyanate-terminated prepolymers thereof are said to be suitable isocyanates. The average functionality of the reactive components (i.e., all the active hydrogen containing components and isocyanates) must range from 197 to 203.

The production of urethane foams and elastomers is well known in the art. Urethanes are formed when NCO groups react with hydroxyl groups. The most common method of urethane production is via the reaction of a polyol and an isocyanate which forms the backbone urethane group. A cross-linking agent may also be added. Depending on the desired qualities of the final urethane product, the precise formulation may be varied. Variables in the formulation include the type and amounts of each of the reactants.

In the case of a urethane foam, a blowing agent is added to cause gas or vapor to be evolved during the reaction. The blowing agent creates the void cells in the final foam, and may be a relatively low boiling solvent or water. A low boiling solvent evaporates as heat is produced during the isocyanate/polyol reaction to form vapor bubbles. If water is used as a blowing agent, a reaction occurs between the water and the isocyanate group to form an amine and CO₂ gas in the form of bubbles. In either case, as the reaction proceeds and the material solidifies, the vapor or gas bubbles are locked into place to form void cells. Final urethane foam density and rigidity may be controlled by varying the amount or type of blowing agent used.

A cross-linking agent is often used to promote chemical cross-linking to result in a structured final urethane product. The particular type and amount of cross-linking agent used will determine such final urethane properties such as elongation, tensile strength, tightness of cell structure, tear resistance and hardness. Generally, the degree of cross-linking that occurs correlates to the flexibility of the final foam product. Relatively low molecular weight compounds with greater than single functionality are found to be useful as cross-linking agents.

Catalysts may also be added to control reaction times and to effect final product qualities. The effects of catalysts generally include the speed of the reaction. In this respect, the catalyst interplays with the blowing agent to affect the final product density. The reaction should proceed at a rate such that maximum gas or vapor evolution coincides with the hardening of the reaction mass. Also, the effect of a catalyst may include a faster curing time, so that urethane foam may be produced in a matter of minutes instead of hours.

Polyols used in the production of urethanes are petrochemicals, being generally derived from ethylene glycol with polyester polyols and polyether polyols being the most common polyols used in urethane production. For semi-rigid foams, polyester or polyether polyols with molecular weights of from 3,000 to 6,000 are generally used, while for flexible foams shorter chain polyols with molecular weight of from 600 to 4,000 are generally used. There is a very wide variety of polyester and polyether polyols available for use, with a particular polyol being used to engineer and produce a particular urethane elastomer or foam having desired particular final toughness, durability, density, flexibility, compression set ratio, and modulus and hardness quality. Generally, lower molecular weight polyols and lower functionality polyols tend to produce more flexible foams than do heavier polyols and higher functionality polyols. In order to eliminate the need to produce, store, and use different polyols, it would be advantageous to have a single versatile component that was capable of being used to create final urethane foams of widely varying qualities.

Further, use of petrochemicals such as polyester or polyether polyols is disadvantageous for a variety of reasons. As petrochemicals are ultimately derived from petroleum, they are a non-renewable resource. The production of a polyol requires a great deal of energy, as oil must be drilled, extracted from the ground, transported to refineries, refined and otherwise processed to yield the polyol. These required efforts add to the cost of polyols, and to the disadvantageous environmental effects of its production. Also, the price of polyols tends to be somewhat unpredictable as it tends to fluctuate based on the fluctuating price of petroleum.

Also, as the consuming public becomes more aware of environmental issues, there are distinct marketing disadvantages to petrochemical-based products. Consumer demand for “greener” products continues to grow.

It would therefore be most advantageous to replace polyester or polyether polyols as used in the production of urethane elastomers and foams with a more versatile, renewable, less costly, and more environmentally friendly component.

Plastics and foams made using fatty acid triglycerides derived from vegetables have been developed, including soybean derivatives. Because soybeans are renewable, relatively inexpensive, versatile, and environmentally friendly, they are desirable as ingredients for plastics manufacture. Soybeans may be processed to yield fatty acid triglyceride rich soy oil and a protein rich soy flour.

Unlike urethanes, many plastics are protein based. For these types of plastics, soy protein based formulations have been developed. U.S. Pat. No. 5,710,190, for instance, discloses the use of soy protein in the preparation of a thermoplastic foam. Such plastics, however, are not suitable for use in applications that call for the particular properties of urethanes. Since urethanes don't utilize proteins in their formulations, soy proteins are not relevant for urethane manufacture.

Epoxidized soy oils in combination with polyols have also been used to formulate plastics and plastic foams, including urethanes. For example, U.S. Pat. No. 5,482,980 teaches use of an epoxidized soy oil in combination with a polyol to produce a urethane foam. A polyester or polyether polyol remains in the formulation, however. Also, as the epoxidation processing of the soy oil requires energy, materials and time, use of an un-modified soy oil would be more advantageous.

Efforts have been made to produce a urethane type cellular plastic from un-modified soy oil. U.S. Pat. Nos. 2,787,601 and 2,833,730 disclose a rigid cellular plastic material that may be prepared using any of several vegetable oils, including soy oil. The foam disclosed in these patents, however, is made from a multistep process requiring the preparation of a prepolymer and, in the case of U.S. Pat. No. 2,833,730, relatively low cross-linker concentrations are urged, resulting in questionable product stability. Further, use of a particular isocyanate, namely toluene diisocyanate, is disclosed which is disadvantageous due to its relatively high toxicity.

An unresolved need therefore exists in industry for a urethane elastomer and a flexible urethane foam, and a method of producing such materials, that are based on a reaction between isocyanates and a relatively inexpensive, versatile, renewable, environmentally friendly material such as vegetable oils as a replacement for polyether or polyester polyols.

It is an object of the invention to provide a flexible urethane foam, useful as an environmentally friendly carpet backing resulting from the product of a reaction between an isocyanate and a vegetable oil as a replacement for a petroleum-based polyester or polyether polyol, along with other reactants.

It is an object of the present invention to provide precoats, foam coats and laminate coats that are particularly useful as carpet-backings and that optimally combine flexibility and elongation characteristics with rigidity, strength and density requisites.

It is a further object of the invention to provide carpet backings manufactured with materials that are more environmentally friendly than those heretofore utilized.

### SUMMARY OF THE INVENTION

The foregoing and other objects are realized by the present invention, one embodiment of which relates to a cellular material useful in the manufacture of carpet backings that is the reaction product of an A-component and a B-component, wherein the A-component is comprised of an aromatic or aliphatic isocyanate (for example phenyl diisocyanate, 4,4′-biphenylene diisocyanate, 2,4-toluene diisocyanate, 2,6-toluene diisocyanate (TDI) ditoluene diisocyanate, naphthalene 1,4-diisocyanate, 2,4′- and/or 4,4′-diphenylmethane diisocyanate (MDI), polymethylene polyphenylene polyisocyanates (polymeric MDI), 1,6-hexamethylene diisocyanate, isophorone diisocyanate, 1,4-cyclohexyl diisocyanate, or any other modified MDI or TDI or vegetable oil based isocyanate or other prepolymer; and the B-component is comprised of:

1) an environmentally friendly vegetable oil based polyol (such as from soybeans) or a vegetable oil based polyol plus a petrochemical polyol or prepolymer;

2) a cross linking agent (such as a multi functional alcohol);

3) a catalyst (amine or metal, for example); and

4) a blowing agent.

Optionally, the B-component may also contain:

5) a surfactant;

6) fillers (e.g., calcium carbonate, aluminum trihydrate and flyash);

7) an aromatic enhancer; and

8) pigment.

### DETAILED DESCRIPTION OF THE INVENTION

The B-component is typically mixed in a standard mix tank and reacted with the A-component (in a one step process) just prior to the point of use. By varying the proportions of the reactants within the B-component and altering the mix with the quantity of A-component, flexibility, rigidity, density and hardness can be controlled (i.e. precoats, foams and laminates acquired). Thus, higher molecular weight and higher functionality isocyanates would result in a less flexible foam than the use of a lower molecular weight and lower functionality isocyanate with the same polyol. Similarly, lower molecular weight and lower functionality cross linkers will result in a more flexible foam than higher molecular weight and higher functionality cross linkers when used with the same polyol.

Upon the combination of A-component and B-component reactants an exothermic reaction occurs which may reach completion in several minutes or several hours depending on the reactants and the concentrations used. The catalyst level is altered to accelerate or decelerate the reaction. Also, the blowing agent level is altered to affect the film structure thus forming a foam or polyurethane elastomer.

One embodiment of the invention relates to its utilization as a precoat layer for carpet. Traditionally a carpet can be broadloom, tile or rugs, woven or tufted into a primary substrate which is typically a woven or non woven, made of various fiber types such as polypropylene or polyester. A typical construction, for example, is a broadloom carpet tufted into a woven polypropylene primary. This construction is then precoated (knife over a roll, sprayed, etc.) on the back component with the biobased polyurethane composition of the invention. This is a very critical part of the process where both application and chemical formulation come together in order to accomplish:

1) penetration and surrounding of the carpet tufts, insuring the tuft-primary adhesion and elevated tuft pull strengths;

2) encapsulation of the individual carpet tuft filaments to prevent pilling or fuzzing; and

3) physical stabilization of the carpet composite.

After the point of precoat application, the biobased precoat is finish-cured, e.g., in a heated oven.

Another embodiment of the invention is its use as a coating over an already precoated carpet described in the above embodiment, in order to laminate thereto a secondary substrate. This substrate can be a woven, non-woven or a composite of both, made of various fiber types such as polypropylene, polyester or combinations thereof. After the introduction of the secondary into the biobased coating layer the composite is finished cured in a heated oven.

This laminated construction offers additional physical stability of the carpet composite through the manufacturing process. The laminated construction offers such additional attributes such as:

1) a bondable surface for direct adhesive installation;

2) physical strength needed during stretching in a direct glue installation; and

3) physical strength and integrity in a stretch-in over pins installation.

An additional embodiment of the invention is its utilization as a foam coating over the above-described precoated carpet. The carpet construction in then finished cured in a heated oven. The advantages of having applied foam to the carpet are:

1) comfort under foot;

2) insulation factors; and

3) carpet fiber/life retention increase.

A still further embodiment of the invention is its use as a foam coating over an already precoated carpet construction described above, followed by introducing a secondary into the foam structure. The secondary substrates that can be employed are described hereinabove. The carpet construction is then finish-cured in a heated oven.

Another embodiment of the invention is its employment as a precoat and laminate in a one step-application process.

The A-component comprises a polyisocyanate, and usually is based on diphenylmethane diisocyanate (“MDI”) or toluenediisocyanate (“TDI”). The particular isocyanate chosen will depend on the particular final qualities desired in the urethane.

The B-component material is generally a solution of a vegetable oil polyol, cross-linking agent, and blowing agent. A catalyst is also generally added to the B-component to control reaction speed and effect final product qualities.

It has been discovered, however, that flexible urethane foams of a high quality can be prepared by substituting the petroleum-based polyol in the B-component preparation with a vegetable oil in the presence of a multi-functional alcohol cross-linking agent having a molar ratio of the OH groups of the cross-linking agent to the OH groups of the bulk vegetable oil is at least 0.7 to 1, and preferably between about 0.7 and 1.2 to 1. The replacement is made on a substantially 1:1 weight ratio of vegetable oil for replaced petroleum-based polyol. The process of producing the urethane does not change significantly with the petroleum-based polyol replaced by the vegetable oil, with all other components and general methods as are generally known in the art. The qualities of the final flexible or semi-rigid urethane foam produced using the vegetable oil are consistent with those produced using a high grade, expensive polyol.

Further, it has surprisingly been discovered that with use of a single vegetable oil, urethane foams of varying and selectable final qualities, including differing flexibilities, densities, and hardnesses, can be made by varying only the primary reactants. It would be difficult, if not impossible, to create such varied final foams using a single petroleum-based polyester or polyether polyol with the same variations in the remaining reactants. Instead, different petroleum-based polyols would be required to produce such varied results.

The use of vegetable oil in the urethane forming reaction also realizes a significant cost savings. Vegetable oils are abundant, renewable, and easily processed commodities, as opposed to polyols, which are petroleum derivatives and which entail significant associated processing costs. As such, they may currently be acquired for a cost of approximately half that of average grade petroleum-based polyester or polyether polyols, and approximately one quarter the cost of high-grade petroleum-based polyester or polyether polyols. Also, as polyols derived from petroleum, they are not renewable and carry a certain environmental cost with them. There is a distinct marketing advantage to marketing products that are based on environmentally friendly, renewable resources such as vegetable oils.

The A-component isocyanate reactant of the urethane of the invention is preferably comprised of a isocyanate chosen from a number of suitable isocyanates as are generally known in the art. Different isocyanates may be selected to result in different final product properties. The A-component reactant of the urethane of the invention preferably comprises diphenylmethane diisocyanate (MDI).

The B-component reactant of the urethane reaction includes at least the vegetable oil, a cross-linking agent, and a blowing agent. It is believed that the isocyanate reacts with the fatty acids of the vegetable oil to produce the polymeric backbone of the urethane.

The vegetable oils that are suitable for use tend to be those that are relatively high in triglyceride concentration and that are available at a relatively low cost. The preferred vegetable oil is soy oil, although it is contemplated that other vegetable oils, such as rapeseed oil (also known as canola oil) and palm oil can be used in accordance with the present invention. Except for the preliminary blowing step, where air is passed through the oil to remove impurities and to thicken it, the soy oil is otherwise unmodified. It does not require esterification as is required for some urethane products of the prior art.

Except for the use of the preferred unmodified, blown soy oil replacing the polyol, the preferred B-component reactant used to produce the foam of the invention is generally known in the art. Accordingly, preferred blowing agents for the invention are those that are likewise known in the art, and may be chosen from the group comprising 134A HCFC refrigerant available from Dow Chemical Co., Midland Mich., methyl isobutyl ketone (MIBK), acetone and methylene chloride. These preferred blowing agents boil to create vapor bubbles in the reacting mass. Should other blowing agents be used that react chemically, such as water, to produce a gaseous product, concentrations of other reactants may be adjusted to accommodate the reaction.

The cross-linking agents of the foam of the present invention are also those that are well known in the art. They must be at least di-functional. The preferred cross-linking agents for the flexible foam of the invention are ethylene glycol and 1,4 butanediol. It has been found that a mixture of these two cross-linking agents is particularly advantageous in the practice of the present invention. Ethylene glycol tends to offer a shorter chain molecular structure with many “dead end” sites, tending to create a firmer final foam resistant to tearing or “unzipping,” while butane diol offers a longer chain molecular structure, tending to create a softer foam. Proper mixture of the two can create engineered foams of almost any desired structural characteristics.

In addition to the B-component's soy oil and blowing agent, one or more catalysts may be present. Preferred catalysts for the urethanes of the present invention are those that are generally known in the art, and are most preferably tertiary amines chosen from the group comprising DABCO 33-VL (containing 33% of 1,4-diaza-bicyclco-octane and 67% dipropylene glycol) a gel catalyst available from Air Products Corporation; DABCO BL-22 blowing catalyst available from the Air Products Corporation; and POLYCAT 41 trimerization catalyst available from the Air Products Corporation.

Also as known in the art, the B-component reactant may further comprise a silicone surfactant which functions to influence liquid surface tension and thereby influence the size of the bubbles formed and ultimately the size of the hardened void cells in the final foam product. This can effect foam density and foam rebound (index of elasticity of foam). Also, the surfactant may function as a cell-opening agent to cause larger cells to be formed in the foam. This results in uniform foam density, increased rebound, and a softer foam.

A molecular sieve may further be present to absorb excess water from the reaction mixture. The preferred molecular sieve of the present invention is available under the trade name L-past.

The preferred flexible and semi-rigid foams of the invention will have greater than approximately 60% open cells. The preferred flexible foam of the invention will also have a density of from 1 to 45 lb. per cubic foot and a hardness of durometer between 20 and 70 Shore “A”.

The urethane foam of the present invention is produced by combining the A-component reactant with the B-component reactant in the same manner as is generally known in the art. Advantageously, use of the vegetable oil to replace the petroleum-based polyol does not require significant changes in the method of performing the reaction procedure. Upon combination of the A and B component reactants, a reaction ensues which generates heat, and which may reach completion in anywhere from several minutes to several hours depending on the particular reactants and concentrations used. Typically, the reaction is carried out in a mold so that the foam expands to fill the mold, thereby creating a final foam product in the shape of the mold.

The components may be combined in differing amounts to yield differing results, as will be shown in the Examples presented in the Detailed Description below. Generally, however, the preferred flexible foam of the invention B-component mixture, when using the preferred components, is prepared with the following general weight ratios:

| | | |
|---|---|---|
| Blown soy oil | 100 | parts |
| Cross linking agent | 8-15 | parts |
| Blowing agent | 8-15 | parts |
| Catalyst | 1-12 | parts |

This preferred B-component formulation is then combined with the A-component to produce a foam. The preferred A-component is comprised of MDI, and is present in an approximate ratio of about 70-85 parts to 100 parts B-component.

Flexible urethane foams may be produced with differing final qualities using the same vegetable oil by varying the particular other reactants chosen. For instance, it is expected that the use of relatively high molecular weight and high functionality isocyanates will result in a less flexible foam than will use of a lower molecular weight and lower functionality isocyanate when used with the same vegetable oil. Similarly, it is expected that lower molecular weight and lower functionality cross linkers will result in a more flexible foam than will higher molecular weight higher functionality cross linkers when used with the same vegetable oil. Also, an ethylene glycol cross linker will result in shorter final chains and a firmer foam, whereas the use of a butane diol cross linker results in longer chains and a softer foam.

The blowing agent may comprise any conventionally employed in the art and include methyl isobutyl ketone, acetone, water, mechanically frothed air and the like.

The above brief description sets forth rather broadly the more important features of the present disclosure so that the detailed description that follows may be better understood, and so that the present contributions to the art may be better appreciated. There are, of course, additional features of the disclosure that will be described hereinafter which will form the subject matter of the claims appended hereto. In this respect, before explaining the several embodiments of the disclosure in detail, it is to be understood that the disclosure is not limited in its application to the details and the arrangements set forth in the following description. The present invention is capable of other embodiments and of being practiced and carried out in various ways, as will be appreciated by those skilled in the art. Also, it is to be understood that the phraseology and terminology employed herein are for description and not limitation.

The polyurethane coatings may be prepared and applied to textiles in the manner described in the U.S. patents described hereinabove as well as U.S. Pat. No. 6,180,686, the entire contents and disclosures of which are incorporated herein by reference.

### EXAMPLE 1

The following materials were added to a 175-gallon mix tank:

| | | |
|---|---|---|
| GCS Soyoyl [polymerized soybean oil] | 399 | lbs. |
| Bayer 3901 [poly(oxyalkylene)polyol] | 100 | lbs. |
| Calcium Carbonate | 798 | lbs. |
| Dipropylene glycol | 15 | lbs. |
| Tripropylene glycol | 15 | lbs. |
| Surfactant-5027 [anionic & nonionic blend] | 2.5 | lbs. |
| T-12 Catalyst [dibutyltin dilaurate] | 1 | lb. |
| UL-6 Catalyst [dibutyltin bis(2-ethylhexyl thioglycolate) | 0.5 | lbs. |
| Aroma enhancer [Maskol] | 0.3 | lbs. |

The mixture was thoroughly mixed and then pumped through 2-inch lines to a pin mixer where it was blended with Bayer Isocyanate (2903) at a ratio of 4:1 (mixture:isocyanate). This mixture was then applied to the back of a polyethylene grass type carpet which had been sewn into the coating range and run around a 200° F. steam drum at 15 feet per minute. The coated carpet was run through a 90 feet long gas fired oven and set at 225° F. Between the heat and the catalysts, the urethane “film” solidified as a firm coating around the tufts of grass. The carpet was then rolled up.

### EXAMPLE 2

The following materials were added to a 175-gallon mix tank:

| | | |
|---|---|---|
| GCS Soyoyl | 110 | lbs. |
| Bayer 3901 | 102.5 | lbs. |
| Calcium Carbonate | 512 | lbs. |
| Dipropylene Glycol | 15.4 | lbs. |
| Tripropylene Glycol | 15.4 | lbs. |
| Water | 1.5 | lbs. |
| T 12 Catalyst | 1 | lb. |
| UL-6 Catalyst | 1 | lb. |
| Maskol | 0.2 | lbs. |

The material was blended for 2 hours and coated on carpet in the following manner:

a.) The carpet was sewn into the production range and run over a steam drum (275° F.) to make the tufts of yarn (yarn direction) more uniform. The carpet was run face down and the above-described mixture applied to the back of the carpet as follows:

1.) The mixture was pumped through 2-inch lines to a pin mixer where it was blended with Bayer 2903 Isocyanate at a 3.5:1 ratio(compound:isocyanate). This material was then pumped through 2 inch lines to the knife which sits above the back of the carpet (the knife scrapes a uniform layer of material on the carpet back as the carpet moves under the blade).

2.) To the polyurethane surface of the carpet/polyurethane compound combination was added a nonwoven backing just prior to moving through a 90 feet long gas fired oven set at 275° F. Between the heat and the catalysts, the urethane “film” solidified as a coating around the tufts of carpet. The carpet was then rolled up.

What is claimed is:

1. A textile having at least one adherent polyurethane backing, said backing being prepared from a polyurethane forming composition which comprises:
(A) a polyisocyanate and
(B) a mixture of a vegetable oil, a cross-linking agent comprised of a multi-functional alcohol present in a ratio to said vegetable oil such that there are at least 0.7 moles of OH groups per mole of bulk vegetable oil, a catalyst, and a blowing agent.

2. The textile of claim 1 wherein said vegetable oil is chosen from the group comprising soy oil, rapeseed oil or palm oil.

3. The textile of claim 1 wherein said vegetable oil comprises blown soy oil.

4. The textile of claim 1 wherein said catalyst is a tertiary amine.

5. The textile of claim 1 wherein the multi-functional alcohol cross-linking agent comprises a blend of ethylene glycol and 1,4 butanediol.

6. The textile of claim 1 wherein the blowing agent is selected from the group consisting of methylisobutyl ketone, acetone, water and mechanically frothed air.

7. The textile of claim 1 wherein said polyisocyanate comprises a diisocyanate and said vegetable oil comprises bulk soy oil.

8. The textile of claim 1 wherein said catalyst is present in the amount of at least 2.5 parts and said poly isocyanate (A) is present in the amount of 70 parts per 100 parts of mixture (B).

9. The textile of claim 1 wherein the polyurethane comprises the reaction product of between 70 and 85 parts of an (A) and 100 parts of (B) and wherein A comprises a diisocyanate and B comprises 100 parts of blown soy oil, between 8 to 18 parts cross-linking agent providing at least 0.7 moles of OH groups per mole of vegetable oil, 1 to 12 parts catalyst and 2 to 14 parts blowing agent.

10. The textile of claim 1 wherein the polyurethane comprises the reaction product of 70 to 85 parts of A and 100 parts of B and wherein A comprises a diisocyanate and B comprises 100 parts blown soy oil, from 8 to 16 parts cross linking agent providing 0.70 to 1.2 moles OH per mole soy oil, from 2.5 to 11 parts catalyst and from 5 to 13 parts blowing agent.

11. The textile of claim 1 wherein the polyurethane comprises the reaction product of 70 to 85 parts of A with 100 parts of B and wherein A comprises a diisocyanate and B comprises 100 parts blown soy oil, from 9 to 14 parts cross linking-agent providing 0.70 to 1.2 moles OH per mole soy oil, from 2 to 6 parts catalyst and from 4 to 9 parts blowing agent.

12. The textile of claim 1 wherein said catalyst comprises a tertiary amine.

13. The textile of claim 1 wherein said catalyst is chosen from the group comprising a mixture of 33% 1,4-diaza-bicyclo-octane and 67% dipropylene glycol; a tertiary amine blowing catalyst; and n, n′, n″, dimethylamino-propyl-hexahydrotriazine tertiary amine.

14. The textile of claim 1 wherein said polyisocyanate is chosen from the group consisting of 2,4 diisocyanate, 4,4 diphenylmethane diisocyanate and 2,4 diphenylmethane diisocyanate.

15. The textile of claim 1 wherein B further comprises from 2-5 parts surfactant agent for affecting foam cell size.

16. The textile of claim 1 wherein B further comprises from 7-12 parts molecular sieve agent for absorbing water.

17. The textile of claim 1 wherein said polyurethane backing has a coating weight of about 20-40 oz/sq. yd.

18. The textile of claim 1 comprising a primary backing material having a pile attached to one component thereof.

19. The textile of claim 1 comprising a floor covering.

20. The textile of claim 1 wherein a secondary textile substrate is laminated to said at least one polyurethane backing.

21. The textile of claim 20 wherein said secondary textile is a woven, non-woven or composite woven/non-woven textile.

22. The textile of claim 1 wherein said polyurethane backing comprises at least two separately applied polyurethane-forming compositions.

23. The textile of claim 22 wherein a secondary textile is laminated between said at least two polyurethane coatings.

24. The textile of claim 22 wherein a secondary textile is laminated to the outermost polyurethane coating.

25. The textile of claim 23 or 24 wherein said secondary textile is a woven, non-woven or composite woven/non-woven textile.

26. A method of preparing the textile of claim 1 comprising coating a textile with at least one polyurethane forming composition which comprises:
(A) a polyisocyanate and
(B) a mixture of a vegetable oil, a cross-linking agent comprised of a multi-functional alcohol present in a ratio to said vegetable oil such that there are at least 0.7 moles of OH groups per mole of bulk vegetable oil, a catalyst, and a blowing agent. and subjecting said at least one coating to conditions which result in the reaction of (A) and (B) to form said polyurethane.

27. The method of claim 26 wherein (A) comprises a diisocyanate and (B) comprises blown soy oil, a cross-linker comprised of a multi-functional alcohol, present in a ratio with said soy oil such that there is at least 0.7 moles of OH group per mole of bulk soy oil, a catalyst and a blowing agent.

28. The method of claim 26 wherein (A) comprises a diisocyanate and (B) comprises blown soy oil, a multi-functional alcohol cross-linking agent present in such quantities that a ratio of moles of OH groups to moles of bulk soy oil is between 0.7 and 1.2 equivalent moles of OH groups to one mole of bulk soy oil, a tertiary amine catalyst and a blowing agent.

29. The method of claim 26 wherein the ratio of (A) to (B) is 70 to 85 parts to 100 parts.

30. The method of claim 26 wherein a secondary textile substrate is laminated to said at least one polyurethane backing.

31. The method of claim 26 wherein said secondary textile is a woven, non-woven or composite woven/non-woven textile.

32. The method of claim 26 wherein said polyurethane backing comprises at least two separately applied polyurethane-forming compositions.

33. The method of claim 32 wherein a secondary textile is laminated between said at least two polyurethane coatings.

34. The method of claim 32 wherein a secondary textile is laminated to the outermost polyurethane coating.

35. The method of claim 32 or 33 wherein said secondary textile is a woven, non-woven or composite woven/non-woven textile.
